(19) United States
(12) Patent Application Publication
(10) Pub. No.: US 2026/0296855 A1
(43) Pub. Date: Oct. 1, 2026

(54) MACHINE FOR HANDLING A LOAD AND/OR A PERSON

(71) Applicant: MANITOU BF, ANCENIS (FR)

(72) Inventor: Guillaume DEROUET, ANCENIS (FR)

(21) Appl. No.: 18/996,531

(22) PCT Filed: Jun. 21, 2023
(86) PCT No.: PCT/FR2023/050927

§ 371 Date: Jan. 17, 2025

(30) Foreign Application Priority Data
Jul. 22, 2022 (FR) FR2207543

(51) Int. Cl. B66F 9/075; B60Q 1/24; B60Q 3/30; B66F 11/04

(52) U.S. Cl. CPC B66F 9/07527; B60Q 1/247; B60Q 3/30; B66F 11/044

(57) ABSTRACT

A machine (1) for handling a load and/or a person, comprising a chassis (2) provided with front wheels (3) and rear wheels (4) for moving over the ground, a system (5) for handling a load and/or a person carried by the chassis (2), a controller (6) for driving the movement of the chassis (2), which can be positioned remotely from the chassis (2), the chassis (2) comprising, on at least one side wall (7) of its side walls, taken in relation to the front/rear direction of the chassis (2), at least one technical compartment and a bonnet (9) for closing the technical compartment, mounted so as to be movable between an open position and a closed position.

The machine (1) comprises a lighting device (10) mounted on the bonnet (9) for closing the technical compartment, and the lighting device (10) is configured so that, in the closed position of the bonnet (9), it illuminates part of the space (11) located behind the front wheels (3), taken in relation to the front/rear direction of the chassis (2), and, in the open position, it illuminates the inside of the technical compartment.

The present invention concerns a machine for handling a load and/or a person.

In particular, it concerns a machine for handling a load and/or a person comprising a so-called travelling automotive chassis equipped with front and rear wheels for its travel on the ground, a system for handling a load and/or a person carried by said chassis, at least one lighting device and a controller for driving the travel of the automotive chassis which controller can be positioned remotely from the chassis, the automotive chassis, which extends longitudinally from the front to the rear of the chassis, comprising on at least one of its lateral flanks, taken in relation to the front/rear direction of the chassis, at least one technical compartment and a cover for closure of said technical compartment, which cover is fitted such as to be mobile between an open position and a closed position.

A machine for handling a load and/or a person equipped with a technical compartment and lighting devices is known as illustrated by documents US 2018/265340 and US 2018/362313. A lighting device of this type can equip the basket of an aerial bucket, as illustrated in document US 2013/187785. Because of their costs, the hourly range of use of these machines is increasing, and handling machines of this type are now frequently used at night. The difficulty for an operator consists of controlling the travel of such a machine at night, in particular when the machine is controlled from a controller positioned remotely from the chassis of the machine.

An objective of the invention is to propose a handling machine of the aforementioned type, the design of which permits optimal use of the machine in particular at night, or when climatic conditions reduce visibility.

For this purpose, the subject of the invention is a machine for handling a load and/or a person, said machine comprising a so-called travelling automotive chassis equipped with front and rear wheels for its travel on the ground, a system for handling a load and/or a person carried by said chassis, at least one lighting device, and a controller for driving the travel of the automotive chassis, which controller can be positioned remotely from the chassis, the automotive chassis, which extends longitudinally from the front to the rear of the chassis, comprising on at least one of its lateral flanks, taken in relation to the front/rear direction of the chassis, at least one technical compartment and a cover for closure of said technical compartment, which cover is fitted such as to be mobile between an open position and a closed position, characterized in that the or at least one of the lighting devices of the machine is fitted on the cover for closure of the or at least one of the technical departments, and in that said lighting device is configured, in the closed position of the cover, to light part of the space positioned at the rear of the front wheels, taken in relation to the front/rear direction of the chassis, and, in the open position, to light the interior of the technical compartment.

The presence of a lighting device on the cover and its design make it possible to facilitate both the remote control of the chassis of the machine and handling of said machine. In fact, the design of the lighting device makes it possible, by lighting the part at the rear of the front wheels in the closed state of the cover, to assist guiding of the rear wheels, in particular when a machine of this type must be brought to a loading ramp equipping a vehicle for transport of said machine. This design of the lighting device makes it possible, in the open state of the cover, to intervene on technical units, such as actuators, which are conventionally accommodated in the interior of the technical compartment, without needing to provide supplementary lighting.

According to an embodiment of the invention, the lighting device comprises a strip of light-emitting diodes.

According to an embodiment of the invention, at least part of the lighting device is secured on said cover by a lug.

According to an embodiment of the invention, the closure cover is, in order to be fitted such as to be mobile between an open position and a closed position, a pivoting cover which is fitted such as to be mobile in pivoting around a so-called longitudinal axis extending in the front/rear direction of the chassis.

According to an embodiment of the invention, in the state in which it is positioned remotely from the chassis, the controller for driving the travel of the automotive chassis has at least one configuration in which it is fitted on the system for handling a load and/or a person carried by said chassis.

According to an embodiment of the invention, the system for handling a load and/or a person carried by said chassis comprises at least one lifting arm which is coupled at one of its ends to the chassis, and, at its opposite end, carries a basket inside which an operator can take his place, and, in the state positioned remotely from the chassis, the controller for driving the travel of the automotive chassis has at least one configuration in which it is coupled to said basket.

According to an embodiment of the invention, the controller for driving the travel of the automotive chassis is a remote control with a radius of action of at least two meters in relation to the chassis.

### BRIEF DESCRIPTION OF THE DRAWINGS

The invention will be well understood by reading the following description of embodiments, provided with reference to the appended drawings in which:

FIG. 1 represents a three-quarter front view in perspective of a machine according to the invention in the closed state of the cover of the technical compartment;

FIG. 2 represents a front view in perspective of a machine according to the invention in the closed state of the cover of the technical compartment;

FIG. 3 represents a schematic view of the cover and of the lighting device associated with the closed state of the cover;

FIG. 4 represents a three-quarter front view in perspective of a machine according to the invention in the open state of the cover of the technical compartment;

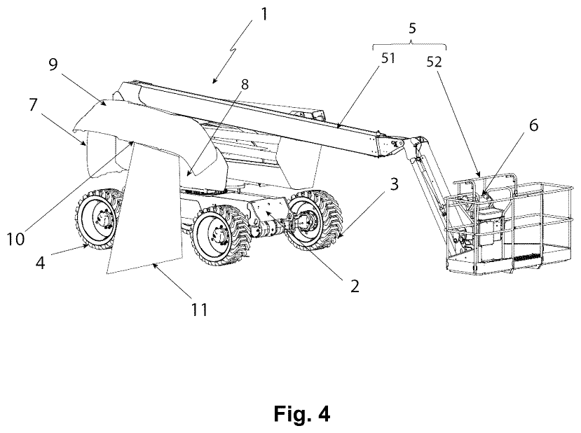

FIG. 5 represents a front view in perspective of a machine according to the invention in the open state of the cover of the technical compartment;

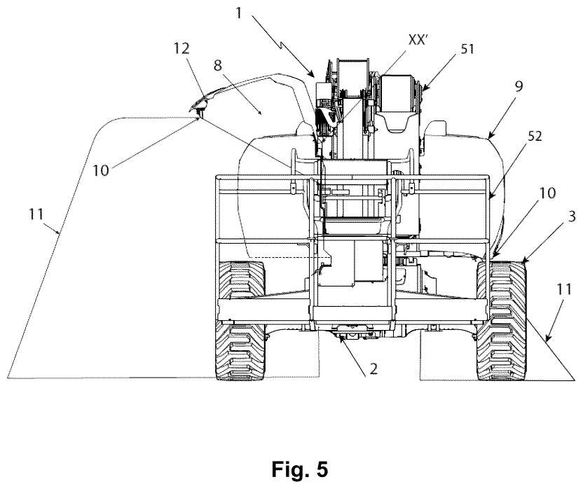

FIG. 6 represents a schematic view of the cover and of the lighting device associated with the open state of the cover.

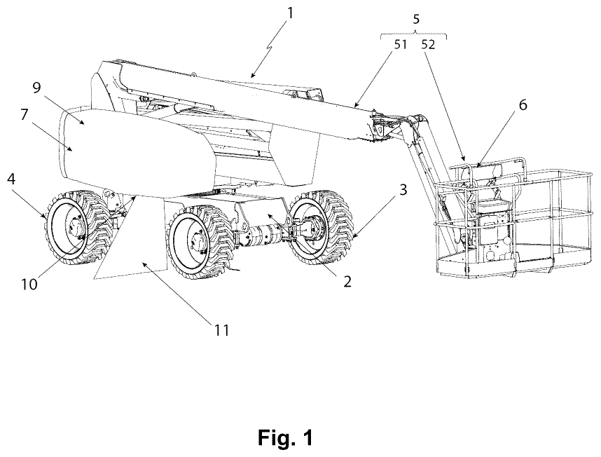

As previously stated, the subject of the invention is a machine 1 for handling of load and/or a person, which can be in accordance with that represented for example in FIG. 1.

This machine 1 for handling a load and/or a person can permit exclusively handling of a load or exclusively handling of a person or both, according to its design.

This machine 1 comprises a travelling chassis 2 with a front part and a rear part. The front and rear parts of the chassis are taken in relation to the direction of advance of the chassis 2.

In the examples represented, this chassis 2 is equipped with two front wheels 3 positioned at the front part of the chassis 2, and two rear wheels 4 positioned at the rear part of the chassis 2.

This chassis 2 is equipped with a driving unit for driving the travel of the machine by rotation of the wheels of the machine. This driving unit will not be described, since it is well known to persons skilled in the art, and its design is unimportant in the present invention.

The handling machine 1 also comprises a system 5 for handling a load and/or a person carried by the chassis 2.

In the examples represented, the system 5 for handling a load and/or a person carried by the chassis 2 comprises at least one lifting arm 51 coupled at one of its ends to the chassis 2, and carrying at its opposite end a basket 52, inside which an operator can take his place. The presence of a basket permits handling of a person and optionally of a load. As a variant, the basket can be replaced by a bucket, handling forks, or any other accessory which permits only handling of a load.

The lifting arm 51 is a pivoting arm fitted such as to pivot around a so-called horizontal axis, parallel to the plane of support on the ground of the wheels of the machine in the state in which the machine is positioned on a horizontal flat ground.

The lifting arm 51 is thus fitted such as to be mobile in pivoting between a low position close to the ground and a high position spaced from the ground.

The chassis 2 extends longitudinally from the front to the rear of the chassis 2, and the lifting arm 51 extends along this longitudinal axis.

The driving unit described above can permit the actuation of one or a plurality of pumps which assist the operation of actuators, such as jacks, for driving in displacement of the lifting arm 51. Once again, operation of this type will not be described, since it is well known to persons skilled in the art.

The machine 1 also comprises a controller 6 for driving the travel of the automotive chassis 2, which can be positioned remotely from the chassis 2. This controller 6 can be in the form of a control panel or console, as in the example represented.

Control units such as levers, knobs, handles or the like equip a controller 6 of this type, and permit in particular control of driving of the travel of the chassis 2 on the ground, by rotation of the wheels.

This control unit 6, which permits control of travel of the chassis 2 remotely from the chassis, can be positioned in the basket 52.

In fact, in the state in which it is positioned remotely from the chassis 2, the controller 6 for driving the travel of the automotive chassis 2 can have at least one configuration in which it is fitted on the system 5 for handling a load and/or a person carried by the chassis 2.

Thus, in the state in which it is positioned remotely from the chassis 2, this controller 6 for driving the travel of the automotive chassis can have at least one configuration in which it is coupled to the basket 52.

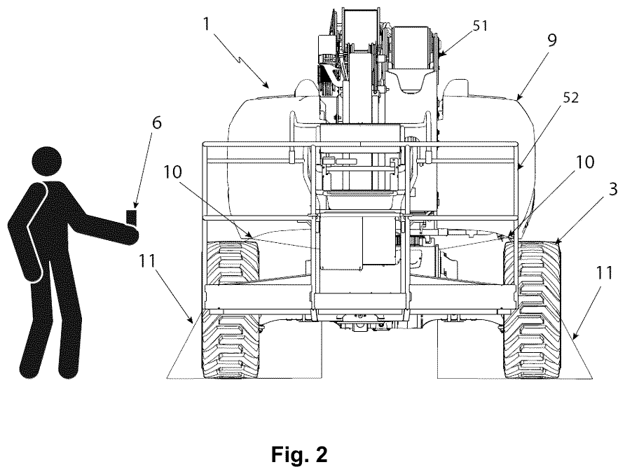

This controller 6 can also be a remote control which can be actuated by an operator on the ground, as illustrated in FIG. 2. In this embodiment, the controller 6 for driving the travel of the automotive chassis can be a remote control with a radius of action in relation to the chassis 2 of preferably at least two meters.

The chassis 2 can be equipped in addition with a control cab inside which an operator can take his place.

Conventionally, on at least one of its lateral flanks 7 or sides, i.e. the part of the chassis which extends from the front part to the rear part of the chassis 2, the automotive chassis 2 comprises at least one technical compartment 8. A technical compartment 8 can be provided at each flank 7, as in the example represented, or at a single one of the lateral flanks 7 of the machine.

This technical compartment 8 accommodates for example the driving unit, pumps or the like. The interior of the technical compartment 8 is accessible via a lateral opening closed by a cover 9.

In the examples represented, this closure cover 9 is a pivoting cover which is fitted such as to be mobile around a so-called longitudinal axis XX', extending in the front/rear direction of the chassis 2, between an open position and a closed position.

During its pivoting displacement for the passage from the closed position to the open position, this closure cover 9 is pivoted upwards. An operator then positions himself below the closure cover 9 in order to be able to intervene on elements positioned in the technical compartment 8.

The machine 1 also comprises one or a plurality of lighting devices, at least one of which, represented as 10 in the figures, is fitted on the closure cover 9 of the, or the at least one, and preferably each of the technical compartments 8.

This lighting device 10 is configured, in the closed position of the cover 9, to light part of the space 11 positioned at the rear of the front wheels 3, taken in relation to the front/rear direction of the chassis 2, and, in the open position, to light the interior of the technical compartment 8.

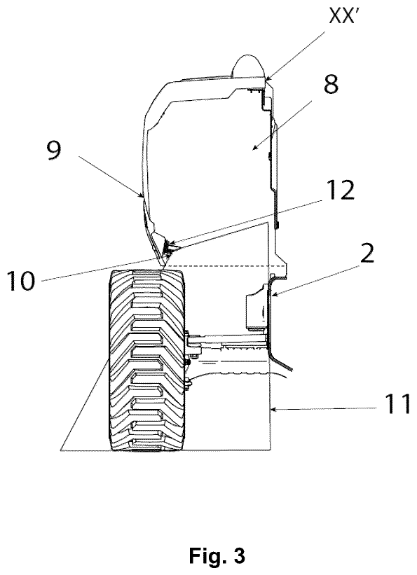

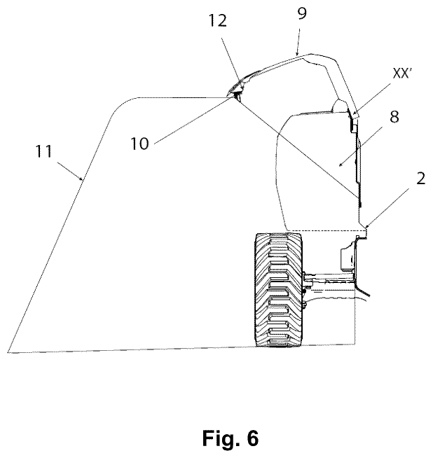

In the examples represented, the lighting device 10 comprises a strip of light-emitting diodes. At least part of the lighting device 10 is secured on the cover 9 by a lug 12, as illustrated schematically in FIGS. 3 and 6.

In practice, the operation of a machine 1 of this type is similar to that of a machine according to the prior art. The presence of a lighting device 10 at the closure cover 9 of the or each technical compartment 8 makes it possible, in the state when the controller 6 for driving the travel of the chassis 2 is positioned remotely from the chassis 2, to control the travel of the machine 1 at night in complete safety, in particular for the purpose of driving the travel of the machine 1 on an inclined ramp.

The presence of this lighting device 10 also makes it possible to intervene on the machine 1 in the middle of the night, at the or one of the technical compartments 8, without needing additional lighting in order to see the interior of said technical compartment 8.

1. A machine (1) for handling a load and/or a person, said machine (1) comprising a so-called travelling automotive chassis (2) equipped with front (3) and rear (4) wheels for its travel on the ground, a system (5) for handling a load and/or a person carried by said chassis (2), at least one lighting device (10), and a controller (6) for driving the travel of the automotive chassis (2), which controller can be positioned remotely from the chassis (2), the automotive chassis (2), which extends longitudinally from the front to the rear of the chassis (2), comprising on at least one of its lateral flanks (7), taken in relation to the front/rear direction of the chassis (2), at least one technical compartment (8) and a cover (9) for closure of said technical compartment (8), which cover is fitted such as to be mobile between an open position and a closed position, characterized in that the or at least one of the devices (10) for lighting of the machine (1) is fitted on the cover (9) for closure of the or at least one of the technical compartments (8), and in that said lighting device (10) is configured, in the closed position of the cover (9), to light part of the space (11) positioned at the rear of the front wheels (3), taken in relation to the front/rear direction of the chassis (2), and, in the open position, to light the interior of the technical compartment (8).

2. The machine (1) for handling a load and/or a person as claimed in claim 1, characterized in that the lighting device (10) comprises a strip of light-emitting diodes.

3. The machine (1) for handling a load and/or a person as claimed in one of claims 1 or 2, characterized in that at least part of the lighting device (10) is secured on said cover (9) by a lug (12).

4. The machine (1) for handling a load and/or a person as claimed in one of claims 1 to 3, characterized in that the closure cover (9) is, in order to be fitted such as to be mobile between an open position and a closed position, a pivoting cover (9) which is fitted such as to be mobile in pivoting around a so-called longitudinal axis (XX′) extending in the front/rear direction of the chassis (2).

5. The machine (1) for handling a load and/or a person as claimed in one of claims 1 to 4, characterized in that, in the state in which it is positioned remotely from the chassis (2), the controller (6) for driving the travel of the automotive chassis (2) has at least one configuration in which it is fitted on the system (5) for handling a load and/or a person carried by said chassis (2).

6. The machine (1) for handling a load and/or a person as claimed in one of claims 1 to 5, characterized in that the system (5) for handling a load and/or a person carried by said chassis (2) comprises at least one lifting arm (51) which is coupled at one of its ends to the chassis (2), and, at its opposite end, carries a basket (52) inside which an operator can take his place, and in that, in the state positioned remotely from the chassis (2), the controller (6) for driving the travel of the automotive chassis (2) has at least one configuration in which it is coupled to said basket (52).

7. The machine (1) for handling a load and/or a person as claimed in one of claims 1 to 6, characterized in that the controller (6) for driving the travel of the automotive chassis (2) is a remote control with a radius of action of at least two meters in relation to the chassis (2).
